(19) United States
(12) Patent Application Publication
(10) Pub. No.: US 2016/0015038 A1
(43) Pub. Date: Jan. 21, 2016

(54) TREATED CROP PLANTS OR PLANT FOOD PRODUCTS WITH DECREASED BACTERIAL VIABILITY AND METHODS AND APPARATUSES FOR MAKING THE SAME

(71) Applicant: EP Technologies LLC, Akron, OH (US)

(72) Inventors: James Ferrell, Stow, OH (US); Nicholas R. Lee, North Canton, OH (US); Daphne Pappas Antonakas, Hudson, OH (US); Sameer Kalghatgi, Copley, OH (US); Tsung-Chan Tsai, Cuyahoga Falls, OH (US); Robert L. Gray, Hudson, OH (US); Erinn R. Bogovich, Ravenna, OH (US)

(21) Appl. No.: 14/799,904

(22) Filed: Jul. 15, 2015

Related U.S. Application Data
(60) Provisional application No. 62/025,331, filed on Jul. 16, 2014.

(51) Int. Cl. A01N 61/00; A01N 31/08; A23B 7/015; A01N 35/04

(52) U.S. Cl. CPC A01N 61/00; A01N 35/04; A01N 31/08; A23B 7/015; A23V 2002/00

(57) ABSTRACT

A treated crop plant or plant food product with decreased bacterial viability relative to an untreated crop plant or plant food product. The treated crop plant or plant food product has at least a 1-log reduction in bacterial viability relative to the untreated crop plant or plant food product. Methods and apparatuses of producing the treated crop plant or plant food product are also provided.

### RELATED APPLICATIONS

This application claims priority to and the benefits of U.S. Provisional Application Ser. No. 62/025,331, filed Jul. 16, 2014, titled TREATED CROP PLANTS OR PLANT FOOD PRODUCTS WITH DECREASED BACTERIAL VIABILITY AND METHODS AND APPARATUSES FOR MAKING THE SAME, which application is incorporated herein by reference in its entirety.

### FIELD OF THE DISCLOSURE

The disclosure relates to treated crop plants or plant food products. Particularly, the disclosure relates to treated crop plants or plant food products having decreased bacterial viability and methods and apparatuses for making the same.

### BACKGROUND

The Centers for Disease Control and Prevention estimate approximately 48 million Americans get sick, 128,000 are hospitalized, and 3,000 die from food-borne diseases in a year. According to the FDA, 131 produce-related outbreaks, attributed to both domestic and imported fresh produce between 1996 and 2010, resulted in 14,132 illnesses, 1,360 hospitalizations and 27 deaths. Food safety practices have advanced in recent years, but despite increased efforts, outbreaks caused by contamination of multiple types of crop plants or plant food products continue to occur. Current methods of sterilizing or decontaminating crop plants or plant food products include chemical treatment, heat treatment, and irradiation.

Plasma is a weakly ionized gaseous medium that contains free electrons, ions, and neutral particles. Non-thermal plasmas are generated when a gas is exposed to an electric field formed between two electrodes, one of which may be grounded. Upon the application of the electric field, the gas molecules and atoms generate free electrons, ions and radicals that participate in reactions within the gas phase and also with materials in contact with the plasma. A non-vacuum plasma system that operates at or below room temperature and at atmospheric pressure conditions is presented for consideration in this application.

### SUMMARY

Disclosed herein are treated crop plants or plant food products with decreased bacterial viability. Also disclosed are methods and apparatuses for producing the crop plants or plant food products.

In one aspect, a treated crop plant or plant food product with decreased bacterial viability is disclosed. The treated crop plant or plant food product has significantly reduced bacterial viability relative to an untreated crop plant or plant food product. The treated crop plant or plant food product has at least a 1-log reduction in bacterial viability relative to the untreated crop plant or plant food product.

In another aspect, a method of decreasing the viability of bacteria on a crop plant or plant food product is disclosed. The method includes exposing a crop plant or plant food product to a plasma activated medium, thereby reducing the viability of bacteria present on the crop plant or plant food product prior to the exposure.

In another aspect, a method of decreasing the viability of bacteria on a crop plant or plant food product is disclosed. The method includes exposing a crop plant or plant food product to a plasma activated medium in a series of short plasma activated mist treatments and brief hold times between short plasma activated mist treatments, thereby reducing the viability of bacteria present on the crop plant or plant food product prior to the exposure.

In another aspect, an apparatus for decontaminating crop plants or plant food products is provided. The apparatus includes a plasma source, a medium generator, and a plasma activated medium applicator. The plasma activated medium applicator is adapted to apply the plasma activated medium to a crop plant or plant food product.

In another aspect, a fluid for treating a crop plant or food product is disclosed. The fluid includes water and a biological additive. At least one of the water and biological additive are activated with plasma.

In another aspect, a biodegradable, non-toxic fluid for treating a crop plant or food product is disclosed. The biodegradable, non-toxic fluid includes water and an additive. The additive includes at least one of lauric acid, cinnamaldehyde, and carvacrol. The water is activated with a plasma gas.

In another aspect, an apparatus for increasing viability of a crop plant or plant food product is disclosed. The apparatus includes a plasma source, a fluid source, and a plasma activated fluid applicator. The plasma activated fluid applicator is adapted to apply the plasma activated fluid to a crop plant or plant food product.

Further areas of applicability of the present disclosure will become apparent from the detailed description, drawings, and claims provided hereinafter. It should be understood that the detailed description, including disclosed embodiments and drawings, are merely exemplary in nature, are only intended for purposes of illustration, and are not intended to limit the scope of the invention, its application, or use.

### BRIEF DESCRIPTION OF THE DRAWINGS

FIG. 1 depicts an exemplary embodiment of an indirect plasma source.

FIG. 2 shows the log reduction of E. coli on spinach leaves following non-thermal plasma-activated water mist exposure.

FIG. 3 shows the log reduction of E. coli and S. aureus following non-thermal plasma-activated mist+Cinnamaldehyde additive treatment on fresh spinach leaves.

FIG. 4 shows the log reduction in S. aureus following non-thermal plasma-activated mist treatment of spinach leaves under different exposure regimens.

FIG. 5 shows the log reduction in E. coli following non-thermal plasma-activated mist treatment of fresh spinach leaves under different exposure regimens.

FIG. 6 shows the log reduction in E. coli following non-thermal plasma-activated water mist exposure of whole pistachio nuts.

FIG. 7 shows an example of an exemplary embodiment which includes a conveyor belt.

FIG. 8 shows the log reduction in E. coli following continuous non-thermal plasma-activated mist treatment.

FIG. 9 shows the log reduction in E. coli following a series of short non-thermal plasma-activated mist treatments, each of which is followed by a brief hold period.

FIG. 10 shows the log reduction in E. coli for a series of short non-thermal plasma-activated mist treatments, each of which is followed by a brief hold period for a water mist, an ethanol formulation mist and a cinnamaldehyde formulation mist; and

FIG. 11 shows the log reduction in E. coli under a soil load for a series of short non-thermal plasma-activated mist treatments, each of which is followed by a brief hold period for a water mist, an ethanol formulation mist and a cinnamaldehyde formulation mist.

### DETAILED DESCRIPTION

Disclosed herein are treated crop plants and plant food products with significantly decreased bacterial viability relative to untreated crop plants or plant food products.

“Treated crop plants or plant food products” are those crop plants and plant food products which are subjected to a treatment due to the actions of a human being, i.e., where a human has taken an action to direct treatment to the particular crop plant or plant food product. An “untreated crop plant or plant food product” is the same crop plant or plant food product which has not been subjected to the particular human-directed treatment, or another human-directed treatment which is intended to produce a similar effect on the crop plant or plant food product.

In particular embodiments, “treated crop plants or plant food products” are those which have been exposed to a plasma activated medium (e.g., water mist) and “untreated crop plants or plant food products” are those which have not been exposed to a plasma activated medium.

In some embodiments, crop plants and plant food products are exposed to a plasma activated medium. Plasma activated medium may be either activated by exposure to direct plasma or exposure to afterglow. Medium activated by exposure to direct plasma are those which come into direct contact with a plasma whereas medium activated by exposure to after-glow which results from plasma that is passed through a filter. Exemplary embodiments for direct plasma and for afterglow are shown and described in U.S. patent application Ser. No. 14/753,969 titled TREATED SPROUT PLANTS WITH DECREASED BACTERIAL VIABILITY AND METHODS AND APPARATUSES FOR MAKING THE SAME, filed on Jun. 29, 2015, which is incorporated by reference herein in its entirety. In some embodiments, plasma activated medium is used to treat plants and plant food products with surfaces that are highly susceptible to tissue damage (e.g., leaf tissue of leafy green plants, i.e., plants where the leaves serve as a food source) and with complicated topographies (e.g., crevices in the surfaces of nuts).

Medium include both liquids and/or fluids and gases. In particular embodiments, gaseous medium include air, helium, argon, neon, xenon, oxygen, nitrogen, vaporized water, ethanol and other vaporized liquids, and mixtures thereof. In some embodiments, the liquid and/or fluid medium is water, saline, ethanol and other organic solvents, water-based or non-aqueous solutions containing salts or acids and aerosolized liquids dispersed in the above mentioned gaseous medium.

Crop plants and plant food products include, without limitation, fruits, vegetables, nuts, grains, etc. In particular embodiments, the crop plants or plant food products are corn, soybean, spinach, lettuce, pistachios, and melons. The crop plants and plant food products can be grown by any method known in the art. In particular embodiments, the crop plants and plant food products are those that are organically grown such that the crop plants and plant food products are not treated with inorganic chemicals.

Crop plants or plant food products with “decreased bacterial viability” are those crop plants or plant food products with fewer bacteria present following treatment than prior to treatment. Decreased bacterial viability can be measured by means known in the art. For example, tissue from both a treated and an untreated crop plant or plant food product can be removed, solubilized, and bacterial growth of the solution measured, e.g., on an agar plate, and quantified. Quantification can be done by determining the number of colony forming units (CFUs) present from each of the samples taken. A logarithmic (log) ratio can then be calculated as a measure of the difference between bacterial viability of treated and untreated samples. In particular embodiments, treated samples have at least a 1-log difference, including at least a 2-log difference, including at least a 3-log difference, including at least a 4-log difference, including at least a 5-log difference, including between a 5-log and a 6-log difference, including about a 5.5 log difference, also including at least a 6-log difference, including at least a 7-log difference, including at least an 8-log difference in bacterial viability relative to untreated samples. In the food industry, a 5-log or greater decrease in bacterial viability is considered sufficient to provide for decontamination of a crop plant or plant food product. Thus, in some embodiments, crop plants or plant food products disclosed herein are “decontaminated” through exposure to a plasma treatment disclosed herein.

Bacteria with decreased viability as a result of plasma treatment of crop plants or plant food products include any food-borne bacterium, ranging from spores to vegetative cells to biofilms, which can reside on a crop plant or plant food product. In particular embodiments, the bacteria with decreased viability include one or more of E. coli, S. aureus, Listeria, and Salmonella.

Treatments applied to crop plants or plant food products preferably produce limited to no damage to the treated crop plant or plant food product. In some embodiments, crop plants or plant food products having limited to no damage are identified as those crop plants or plant food products with low levels of electrolyte conductivity. In some embodiments, crop plants or plant food products with low levels of electrolyte conductivity are those with a conductivity of less than about 100 microSiemens/10 g of tissue, including those with an electrolyte conductivity of less than about 90 microSiemens/10 g, including those with an electrolyte conductivity of less than about 60 microSiemens/10 g, including those with an electrolyte conductivity of less than about 30 microSiemens/10 g.

The treated crop plants or plant food products disclosed herein may be produced by applying a method which, in one aspect, includes the step of exposing a crop plant or plant food product to a plasma activated medium. The method can be used to produce treated crop plants or plant food products with significantly decreased bacterial viability. The plasma activated medium is any medium that is activated by exposure to a plasma. In some embodiments, the plasma activated medium is a gas or a fluid. Any gas or fluid that can be activated by exposure to a plasma and to which crop plants or plant food products can safely be exposed can be used. In particular embodiments, the plasma activated medium is water.

Crop plants or plant food products with significantly decreased bacterial viability and/or limited damage are preferably produced by applying the method for a limited time period. In some embodiments, exposure is carried out for time periods of less than about a minute, including time periods of less than about 45 seconds, including time periods of less than about 30 seconds, including time periods of less than about 15 seconds. Exposure of crop plants or plant food products for these limited time periods can be used to produce crop plants with greater than about a 1-log, including greater than about a 3-log, including greater than about a 5-log reduction in bacterial viability. In a particularly specific embodiment, a 5.5 log reduction in bacterial viability is produced in about 1 minute of exposure. The unexpectedly large reductions in bacterial viability over short exposure times allows for both fast processing of crop plants and plant food products and can aid in limiting the damage to crop plant or plant food product tissue. For example, in some embodiments, exposure times of less than about a minute are expected to produce about 70% of the tissue damage as exposure times of upwards of five minutes. Even the longer exposure times are still expected to be significantly less harmful and residue-free to crop plants and plant food product tissue than conventional methods such as bleach. In some embodiments, even extended exposure times of upwards of five minutes result in crop plants or plant food products with less than about 100 microSiemens/10 mg of electrolyte leakage, or less than about one-third of the damage produced with conventional methods.

In some embodiments, two or more exposures for very short time periods with hold times there between are carried out. In some exemplary embodiments the short period of time is less than about 30 seconds, including less than about 20 seconds, including less than about 10 seconds, including about 5 seconds. In some exemplary embodiments, the brief hold period of time is less than about 1 minute, including less than about 45 seconds, including less than about 30 seconds, including about 15 seconds. The brief period of time may be lengthened and still result in decreased viability of the bacteria, however, in many applications, it is preferred to have the brief period of time be less than about 1 minute so that the process is easy to integrated into an existing process line.

Exposure of crop plants or plant food products for these multiple exposure time periods with hold times there between can be used to produce crop plants with greater than about a 1-log, including greater than about a 3-log, including greater than about a 5-log reduction in bacterial viability. In a particularly specific embodiment, a 5.5 log reduction in bacterial viability is produced in about 1 minute of exposure. The unexpectedly large reductions in bacterial viability over multiple short exposure times followed by hold times allows for both fast processing of crop plants and plant food products and can aid in limiting the damage to crop plant or plant food product tissue. In addition, this approach allows for treatment of products at a plurality of inspection stations that currently exist in food production lines. In addition, in some embodiments, a plurality of exposure times of less than about 15 seconds with hold times there between are expected to produce minimal to no tissue damage.

The methods may be carried out by exposing the crop plants or plant food products to a plasma activated medium alone, or, in some embodiments, in combination with additives to enhance the effects of the plasma activated medium. Any additive that can decrease bacterial viability and/or reduce tissue damage and to which crop plants or plant food products can be safely exposed can be included.

In some embodiments, it is preferable that additives are biological in nature, i.e., of the type that are readily broken down by a mammalian digestive system. In particular embodiments, additives used include one or more of lauric acid, cinnamaldehyde, and carvacrol. In some embodiments, the inclusion of these or other additives results in a greater decrease in bacterial viability and/or helps decrease the extent of crop plant or plant food product tissue damage. In some embodiments, inclusion of additives helps lessen tissue damage by decreasing the exposure time to reach a given decrease in bacterial viability. In an even more specific embodiment, the inclusion of an additive decreases the exposure time needed to achieve the desired result by at least about 25%, including at least about 33%, including at least about 50%. Thus, additives unexpectedly appear to act synergistically with plasma activated medium to decrease bacterial viability on crop plants or plant food products. The additives disclosed herein have native antimicrobial properties. It is Applicants' belief that the additives described in this disclosure inhibit glucose uptake and disrupt bacterial cell membrane permeability. The reactive species within the plasma discharges are capable of further membrane destabilization. Without being bound by theory, the synergistic antimicrobial effect is believed to be linked to cooperative bacterial cell membrane attack followed by inhibition of intracellular energetic processes due to the presence of the additive compound(s).

The methods may be carried out and/or the crop plants or plant food products produced by using an apparatus as disclosed herein. In some embodiments, an apparatus used to carry out the methods and/or for producing the crop plants or plant food products disclosed herein includes a plasma source, a medium generator, and a plasma activated medium applicator. In some embodiments, the plasma activated medium applicator is preferably adapted to apply the plasma activated medium to a crop plant or plant food product.

An exemplary apparatus for plasma activated medium treatment of crop plants or plant food products is shown in FIG. 1. Referring to FIG. 1, an apparatus for plasma treatment is provided. The apparatus contains a medium generator 101. The medium generator 101 generates a medium, such as, for example, a mist of water droplets in air, which is passed through plasma generated by plasma generator 102. The medium is activated by plasma from the plasma generator 102. The activated medium 103 is directed to a crop plant or plant food product 104. The crop plant or plant food product 104 is placed at a distance from the apparatus to allow efficient exposure of the crop plant or plant food product 104 to the activated medium 103, with limited to no damage to the crop plant or plant food product 104. Any appropriate distance may be used. In some embodiments, the crop plant or plant food product 104 is placed at a distance between about 2 mm and about 30 mm, including between about 5 mm and about 27 mm, including between about 10 mm and about 20 mm, including at about 15 mm from the apparatus. Although specific ranges are disclosed herein, these distances any be increased by varying plasma settings and/or including one or more stabilizers in the medium that extend the life of the activated species. Accordingly the distances are not limiting on the inventive concepts disclosed herein.

The distance can be varied separately or in combination with varying a scale setting on the apparatus regulating the generation of the medium such that the activated medium 103 flows to the crop plant or plant food product 104 at an appropriate rate. In some embodiments, variations in the distance and the scale setting on the apparatus are carried out to produce a flow rate of the activated medium 103 to the crop plant or plant food product 104 of about 1 mg of the activated medium 103 per minute to about 20 mg of the activated medium 103 per minute, including about 2 mg to about 8 mg of the activated medium 103 per minute, including about 4 mg to about 6 mg of the activated medium 103 per minute, including about 5 mg of the activated medium 103 per minute.

It should be understood that the apparatus need not be in any particular shape or size. The apparatus need only contain elements that allow for activation of a medium by plasma and the exposure of a crop plant or plant food product to the activated medium. In that regard, the apparatus may be a single unit or multiple units, and can contain indirect plasma treatment options. In some embodiments, the apparatus is designed for use by employees at food processing facilities. In some of these embodiments, the apparatus is designed as a glove that, in some embodiments, fits over the hand and which can direct plasma treatment to crop plants or plant food products handled by the food worker. In some embodiments, the activated mist is collected and condensed into a liquid. The liquid, rather than the mist, may then be used to treat the crop plant or plant food product 104.

In other embodiments, such as is shown in FIG. 7, the apparatus is a part of a conveyor system that allows for the treatment of crop plants or plant food products that pass on the conveyor system. The apparatus may be placed in any orientation relative to the crop plants or plant food products that pass on the conveyor system. In a particular embodiment, the apparatus is located above a conveyor belt such that crop plants or plant food products are treated as they pass under the plasma activated medium. The exemplary embodiment of a treatment apparatus 700 for treating crops, such as sprout plants that includes a conveyor system 701, 702. Treatment apparatus 700 includes a feed conveyor 701 that feeds a crop plant 704 to treatment conveyor 702 which moves the crop plants in direction F. The exemplary embodiment includes one or more pre-wash stations 710 that spray the crop 704 with a pre-wash to wash of dirt and contaminants. In some exemplary embodiments, conveyor 702 vibrates and flips the crop plant 704 around. Treatment apparatus 700 includes one or more plasma treatment stations 714. The exemplary plasma treatment station 714 provides a plasma activated medium in the form of a mist to the crop 704. In some embodiments, plasma treatment station 714 is a dry plasma treatment station and the plasma activated medium is a gas to the crop 714. In some embodiments, the plasma activated medium is activated by direct plasma and in some embodiments; the plasma activated medium is activated by indirect plasma. At rinse station 718, the crop 704 is rinsed, with for example, a water spray 720. In many cases it is not necessary to rinse the crop 704 after the crop 704 is treated with the plasma activated medium. Accordingly, in some embodiments, rinse station 718 is not used or required. In some embodiments, the crop 704 is completely rinsed prior to entering the plasma treatment station. In the exemplary embodiment, a water supply 730 and a gas supply 732 is provided to all of the stations. In some embodiments, the gas 732 supply is only supplied to the plasma treatment station 714. In some embodiments, the gas 732 may be any of the gases identified herein.

While apparatuses for indoor use have generally been described herein, the apparatus can be used indoors or outdoors. In that regard, apparatuses designed for outdoor use can be of any form that contains a power source sufficient to power the apparatus whereby a non-thermal plasma is generated. The power source could be integrated into the apparatus or provided on a use basis. In some embodiments, the power source is selected from microsecond, sinusoidal, nanosecond, and radiofrequency (RF) power sources. In some embodiments, the apparatus is designed for use on crop plants and plant food products in the field. In some embodiments, the apparatus is designed for crop plants and plant food products which have been removed from the field.

### EXAMPLES

The following examples illustrate specific and exemplary embodiments, features, or both, of the methods disclosed herein. The examples are provided solely for the purpose of illustration and should not be construed as limitations on the present disclosure.

### Example 1

### Additives Work Synergistically with Plasma Treatment to Decrease Bacterial Viability

A. Plasma Treatment Decreases E. coli Viability on Spinach.

This Example shows the effects of plasma mist treatment on the viability of E. coli present on spinach.

a) Inoculation of Leafy Greens.

E. coli (ATCC 35150) cultures were grown to stationary phase in tryptic soy broth (TSB; Difco, Becton Dickinson, Franklin Lakes, N.J.). Aliquots of the prepared cultures were mixed into a volume of sterile Milli-Q water (Millipore, Billerica, Mass.) that yields an overall bacterial inoculum percentage of 2%. Thirty microliter aliquots of the bacterial culture were used to spot inoculate regions on the leaf surface of each leaf sample. Cultures were air dried on the leaf samples for 1 hour.

b) Non-Thermal Plasma Mist Application.

An Ultrasonic 360 humidifier (Safety 1^{st}; Columbus, Ind.) was connected to plastic tubing and fed into a custom small-scale plasma generator. The plasma configuration consisted of two parallel brass plate electrodes that have an area of 40 mm×45 mm and thickness of 5 mm. Polyetherimide was used as the housing material for the electrodes. The upper electrode was connected to a high voltage power supply (1-20 kV) with operating parameters that can be adjusted while the lower electrode is grounded. The adjustable outlet of the setup released plasma-activated water mist onto inoculated leaves fixed 2 mm beneath the opening. Plasma-activated water mist was applied to the inoculated leaves at intervals from 15 seconds to 2 minutes. After exposure, leaves were placed into sample tubes and supplied with sterile brain heart infusion broth (Fisher Scientific, Pittsburgh, Pa.) and incubated at 37° C. until enumeration.

c) Generation of Plasma-Activated Water.

Plasma activated water was generated using the plasma electrode configuration similar to that described in the previous section. Amber sample vials (Cole Parmer, Vernon Hills, Ill.) were submerged in ice water baths at a constant temperature of 0° C. and fixed 2 mm beneath the outlet. The mist collection process was operated at intervals that range from 30 seconds to 5 minutes. Throughout plasma generation, Hydrion® pH strips (Micro Essential Labs, Brooklyn, N.Y.) and strips designed to measure nitrate, nitrite, ozone, and peroxides were used (Quantofix, Sigma Aldrich, St. Louis, Mo.). Plasma-activated water was applied to the inoculated leaves at intervals that ranged from 30 seconds to 5 minutes.

d) Detection of Surviving Pathogenic Bacteria.

Bacterial viability was after plasma exposure. Leaves were removed from the incubator and gently stomached in a sterile 0.1% peptone solution with a Seward 400C Stomacher (Seward, West Sussex, UK) for 2 minutes. The homogenate was serially diluted and plated onto Brillance coliform selective agar (Oxoid, Lenexa, Kans.). Dilutions were also plated on brain heart infusion agar to serve as an internal control. The plates were then incubated at 37° C. for 18 hours. Bacterial cell enumeration was collected the following day using the Neutec Flash and Grow Colony Counter, (Neutec, Farmingdale, N.Y.). Data was analyzed using GraphPad Prism and InStat graphical and statistical software (GraphPad Software, Inc., La Jolla, Calif.).

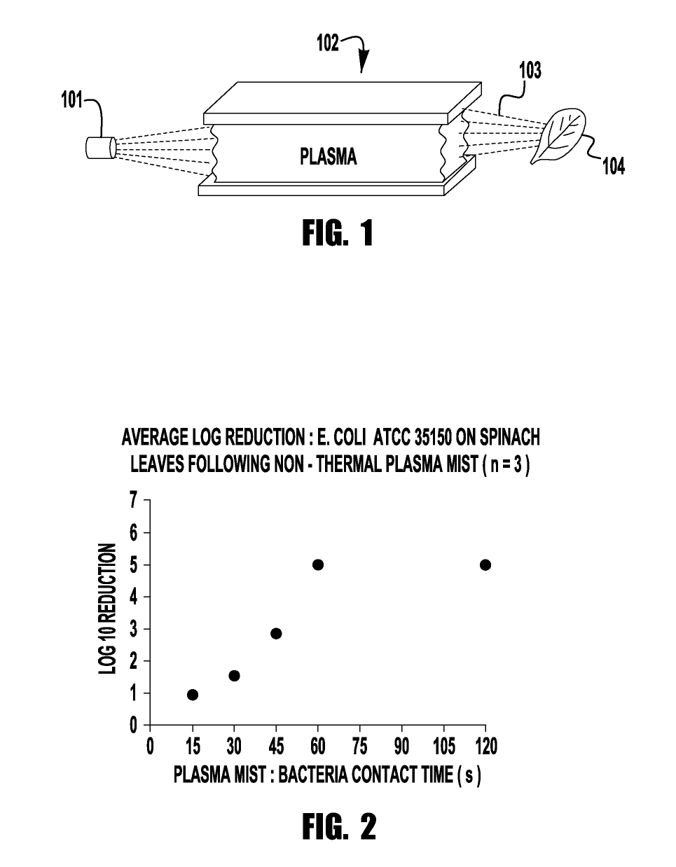

Results of the experiments are shown in FIG. 2. As shown in FIG. 2, spinach exposed to indirect plasma treatment for about 1-minute exhibited about a 5-log reduction in E. coli viability.

B. The Additive Cinnamaldehyde Acts Synergistically with Plasma Treatment to Decrease Viability of E. coli and S. aureus on Spinach.

This Example shows the synergistic effects of cinnamaldehyde with plasma treatment on the viability of E. coli (EC) and S. aureus (SA) present on spinach.

Spinach was exposed to bacterial cultures, plasma mist was applied to the contaminated spinach, and testing for bacterial viability was done as described in the prior example. Where the additive cinnamaldehyde (CIN) is used, it can be introduced in the plasma zone together with water to form plasma activated mist or can be applied in liquid form after the exposure of the spinach to the plasma mist.

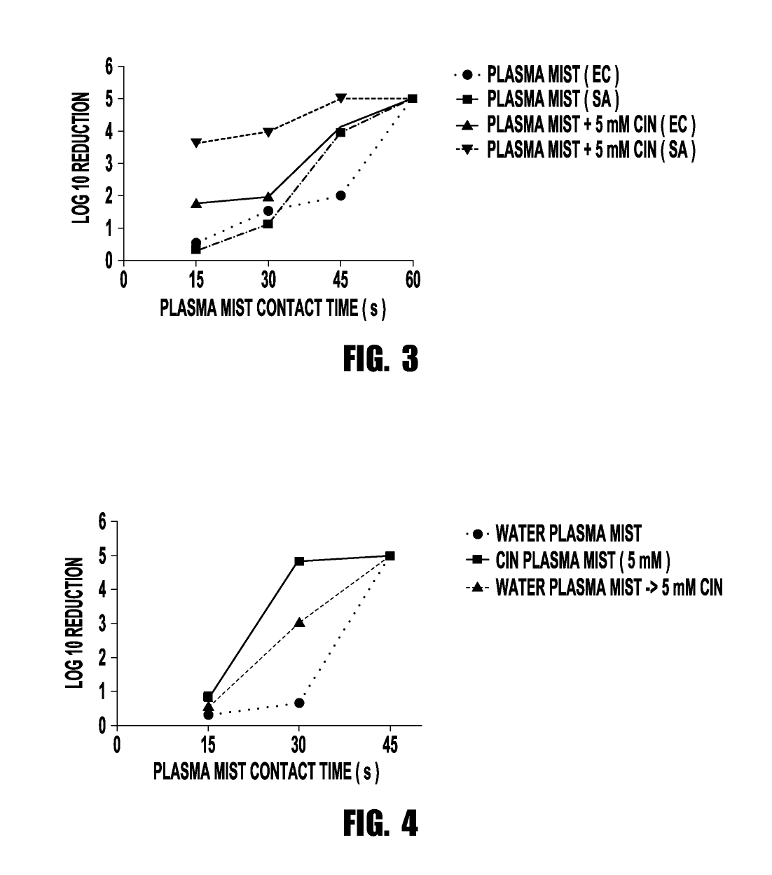

Results of these experiments are shown in FIGS. 3-5. As shown in FIG. 3, exposure of spinach leaves to cinnamaldehyde following plasma mist exposure decreases the plasma mist exposure time to produce a particular reduction in bacterial viability. Whereas about a one minute exposure to plasma mist alone (Plasma Mist (SA)) produced about a 5-log reduction in S. aureus viability, a similar reduction in viability was seen with only about 45 seconds of plasma mist exposure when 100 μl of cinnamaldehyde was added (Plasma Mist+5 mM CIN (SA)). Similarly, whereas about a 45 second exposure to plasma mist alone (Plasma Mist (EC)) produced about a 2-log reduction in E. coli viability, a similar reduction in viability was seen with only about 30 seconds of plasma mist exposure when the additive was included (Plasma Mist+5 mM CIN (EC)). Furthermore, when the additive was used following 45 seconds of plasma mist exposure, nearly twice the reduction in E. coli viability was seen as without the additive.

As shown in FIGS. 4-5, including the additive in the plasma mist (CIN Plasma Mist (5 mM)) provided a further enhancement in the effect over the later addition of the additive (Water Plasma Mist→5 mM CIN).

In contrast to the enhancements seen when the additives were combined with the plasma mist, use of the additives alone had a negligible effect. For example, the logᵢₙ reduction caused by additive application, alone, was less than 0.2 for S. aureus and 0.4 for E. coli.

C. The Additive Carvacrol Acts Synergistically with Plasma Treatment to Decrease Viability of E. coli on Pistachio Nuts.

This Example shows the synergistic effects of carvacrol with plasma treatment on the viability of E. coli present on pistachio nuts.

Pistachio nuts were exposed to bacterial cultures, plasma mist was applied to pistachio nuts, and testing for bacterial viability was done as described for spinach in the prior example. In cases where the additive carvacrol is used, it can be applied with or after the exposure of the nuts to the plasma mist.

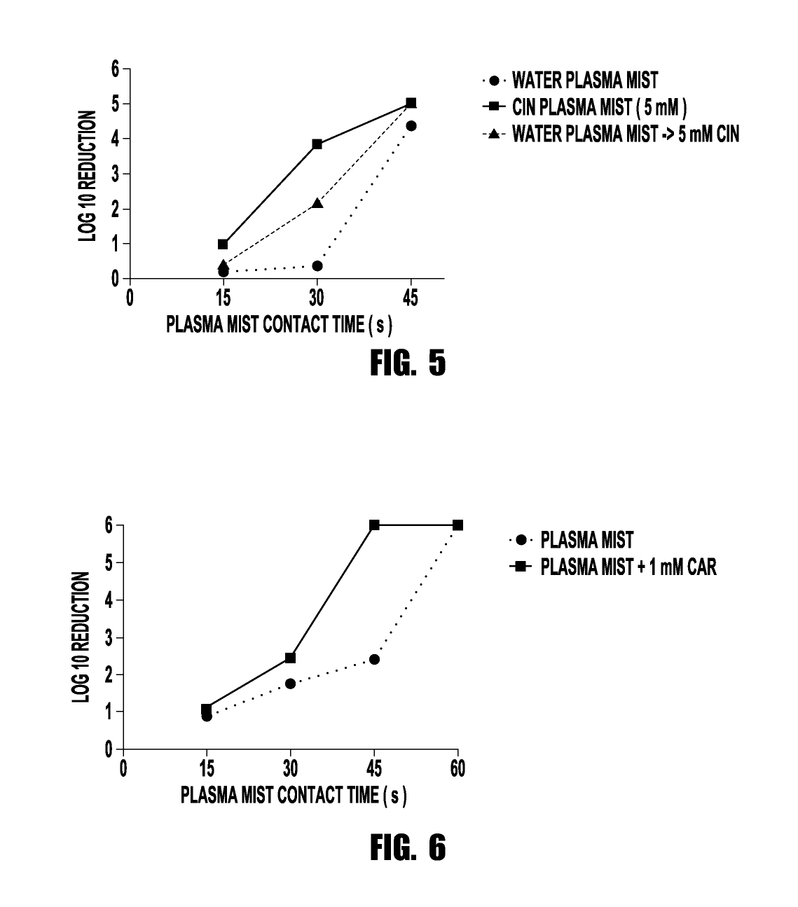

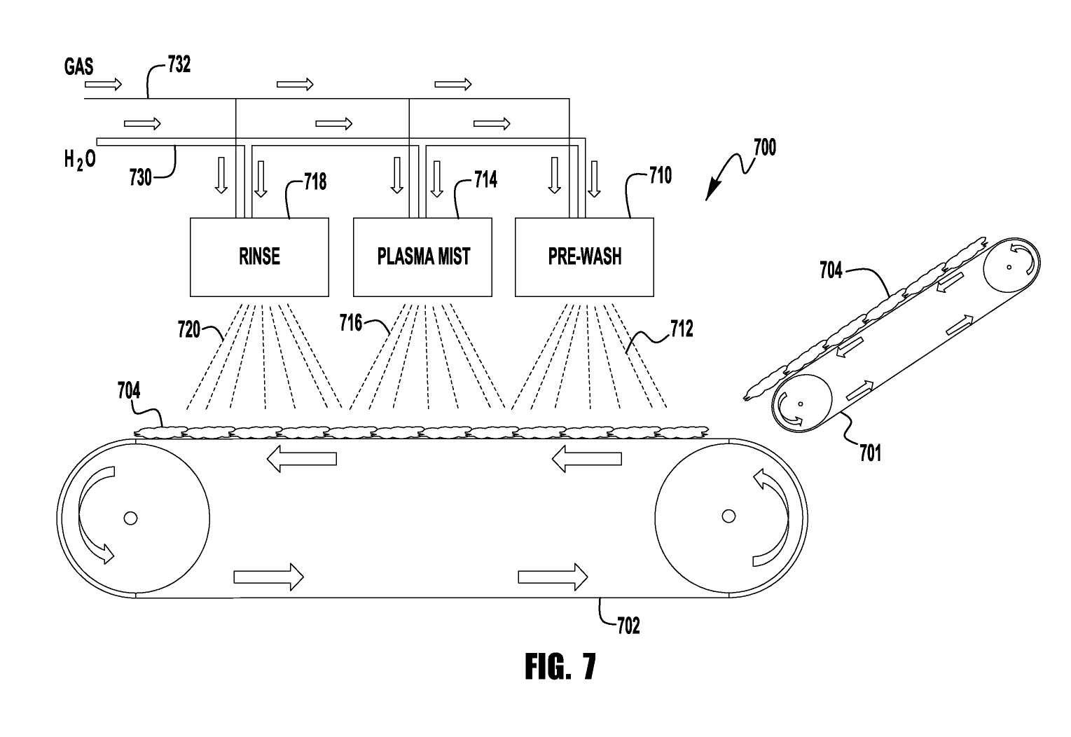

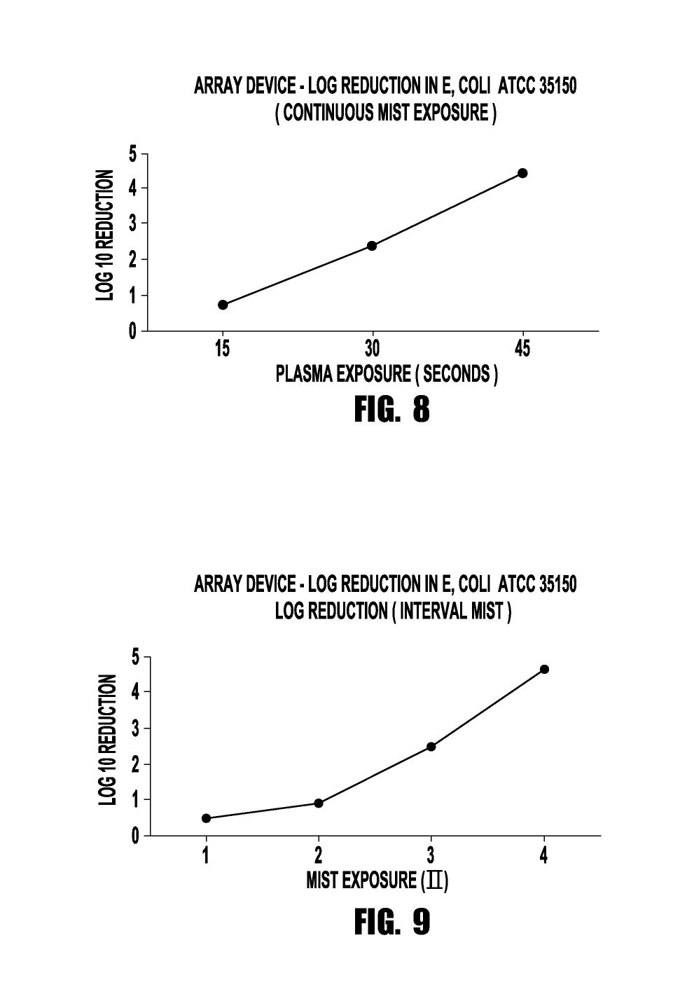

Results of these experiments are shown in FIG. 6. As shown in FIG. 6, exposure of the nuts to carvacrol following plasma mist exposure decreases the plasma mist exposure time to produce a particular reduction in bacterial viability. Whereas about a 45 second exposure to plasma mist alone (Plasma Mist) produced about a 2-log reduction in E. coli viability, a similar reduction in viability was seen with only about 30 seconds of plasma mist exposure when the additive was included (Plasma Mist+1 mM CAR). Furthermore, when the additive was used following 45 seconds of plasma mist exposure, nearly three times the reduction in E. coli viability was seen as without the additive. In contrast to the enhancements seen when the additives were combined with the plasma mist, use of the additives alone had a negligible effect as the log₁₀ bacterial viability was less than 0.4 logs.

### Example 3

### Plasma Treated Plants with Reduced Bacterial Viability have Limited Tissue Damage

This Example shows the effects of plasma treatment and other treatments for reducing bacterial viability on spinach leaves.

Briefly, a large number of individual spinach pieces were exposed to water, bleach, or to plasma at different exposure intervals. The leaves were then placed into deionized water for 30 minutes and an electrolyte conductivity probe was used to measure conductivity of the solution. The reading from the probe was extrapolated based on a higher mass of leaves (˜10 grams).

Results of the experiments are shown in Table 1 below.

TABLE 1
Electrolyte conductivity of spinach leaves.

| | Average Conductivity | Average | Conductivity |
|---|---|---|---|
| | (microSiemens/Leaf) | Mass/Leaf (g) | (microSiemens/10 g) |
| Negative control (DI Water) | 0 | 0.36 | 0 |
| Positive control (200 ppm) | 15 | 0.36 | 421.35 |
| Plasma Mist 0.5 Min | 1 | 0.36 | 28.09 |
| Plasma Mist 1 Min | 2 | 0.36 | 56.18 |
| Plasma Mist 2 Min | 2 | 0.36 | 56.18 |
| Plasma Mist 5 Min | 3 | 0.36 | 84.27 |

As shown in the table, even after five minutes of exposure to plasma mist, the spinach leaves exhibited less than ⅓ of the damage of spinach leaves treated with bleach.

### Example 4

### Interval Mist Treatment Followed by Hold Times Provide Increased Efficacy

This Example shows the unexpected increased efficacy by applying a series of two or more short duration mist plasma treatments followed by brief hold times over continuous mist treatments. Results of these experiments are shown in FIGS. 8 and 9.

FIG. 8 illustrates log reduction of E. coli for continuous mist treatments. After 15 seconds of continuous plasma activated mist treatment, a 1 log reduction in E. coli was observed. After 30 seconds of continuous mist treatment, a log reduction of slightly under 2.5 log reduction was observed, and at 45 seconds of continuous mist treatment, a log reduction of about 4.5 was observed.

FIG. 9 illustrates log reduction of E. coli based on multiple short (e.g. 5 second) duration mist plasma treatments followed by brief hold times (e.g. 15 seconds). As can be seen in the graph, a series of two 5 second plasma mist durations followed by 15 second hold times results in about the same log reduction as 15 seconds of continuous plasma mist treatment. A series of three 5 second plasma mist treatments followed by 15 second hold times results in about the same log reduction as 30 seconds of continuous misting. A series of four 5 second plasma mist treatment durations followed by 15 second hold times results in about the same log reduction as 45 seconds of continuous misting. Thus, one can achieve substantially the same log reduction utilizing far less plasma activated mist by applying multiple short duration plasma mist treatments followed by brief hold times as they can with continuous mist applications, e.g. four 5 second mist applications uses 20 seconds of plasma activated mist and achieves a better result than 45 seconds of continuous plasma activated mist.

### Example 5

### The Additive Cinnamaldehyde Improves Effacacy

A. Cinnamaldehyde Acts Synergistically with Plasma to Decrease Viability of E. coli.

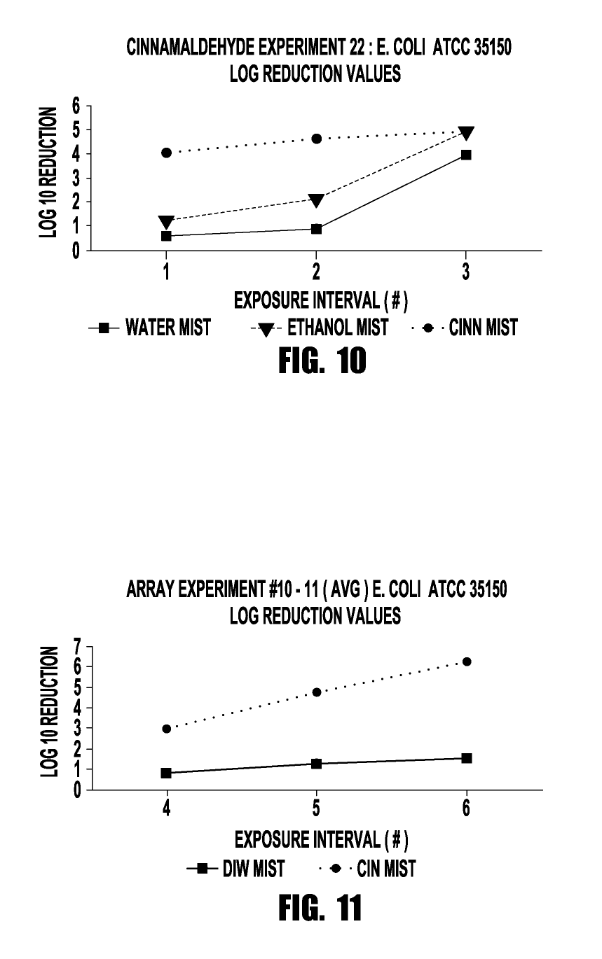

This Example shows the synergistic effect of the additive cinnamaldehyde in a plasma activated medium. The experiments were conducted using the mist application approach described above with one or more short mist applications followed by a brief hold times. As can be seen in FIG. 10, plasma activated deionized water mist activated by plasma for two short mist applications, each followed by brief hold times, had less than about 1 log reduction and slightly less than 4 log reduction after 3 short mist applications with brief hold times there between. An ethanol formulation (deionized water and 10% ethanol) performed better than the deionized water with for each of the identified number of exposure cycles. A cinnamaldehyde formulation (89.0% water, 10% ethanol and 0.1% cinnamaldehyde) performed significantly better than either deionized water mist alone or deionized water and ethanol mist. Surprisingly, even for only single short plasma activated cinnamaldehyde formulation mist treatment, the addition of cinnamaldehyde increased the log reduction by about 3 logs. The log₁₀ reduction caused by additive cinnamaldehyde alone, was less than 0.2 for S. aureus and 0.4 for E. coli.

B. The Additive Cinnamaldehyde Acts Synergistically with Plasma to Decrease Viability of E. coli in the Presence of a Soil Load Present.

This example shows the synergistic effect of the additive cinnamaldehyde in a plasma activated medium for decreasing viability of E. coli in the presence of a soil load. In these experiments a soil load was simulated by inoculating the bacteria in nutrient rich broth (BHIB) instead of minimal PBS buffer (or water).

The experiments were conducted using the mist application approach described above with between four and six short mist applications, each of which was followed by a brief hold times. As can be seen in FIG. 11, the cinnamaldehyde formulation (89.0% water, 10% ethanol and 0.1% cinnamaldehyde) performed significantly better than the plasma activated deionized water mist. After a series of six short mist applications followed by a brief hold times, the plasma activated cinnamaldehyde formulation mist produced about a 6 log reduction in E. coli verses a less than about 2 log reduction with the plasma activated deionized water mist. This example demonstrates the ability of cinnamaldehyde in a plasma activated medium to overcome a soil load. The logᵢₙ reduction caused by cinnamaldehyde additive alone was less than 0.2 for S. aureus and 0.4 for E. coli.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative compositions or formulations, and illustrative examples shown and described. Accordingly, departures may be made from such details without departing from the spirit or scope of the applicant's general disclosure herein.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

As used in the description of the invention and the appended claims, the singular forms “a,” “an,” and “the” are intended to include the plural forms as well, unless the context clearly indicates otherwise.

1. A method of decreasing the viability of bacteria on a crop plant or plant food product, the method comprising:
exposing a crop plant or plant food product to a plasma activated medium multiple times with a hold period between the exposures to the plasma activated medium;
thereby reducing the viability of bacteria present on the crop plant or plant food product prior to the exposure.

2. The method of claim 1, wherein the medium is selected from a gas and/or a fluid.

3. (canceled)

4. The method of claim 1, wherein the viability of the bacteria is reduced by at least 3-log following the exposure.

5. The method of claim 4, wherein the viability of the bacteria is reduced by at least 5-log following the exposure.

6. (canceled)

7. The method of claim 1, wherein the exposures occurs for a period of time of less than about 1 minute.

8. The method of claim 1, wherein the bacteria comprise at least one of E. coli and S. aureus.

9. (canceled)

10. (canceled)

11. The method of claim 1, further comprising a biological additive.

12. The method of claim 11, wherein the biological additive is selected from the group consisting of lauric acid, cinnamaldehyde, and carvacrol.

13. (canceled)

14. (canceled)

15. (canceled)

16. The method of claim 1, wherein the crop plant or plant food product exposed to the plasma activated medium has an electrolyte conductivity of less than about 100 microSiemens/10 g of exposed crop plant or plant food product.

17. A treated crop plant or plant food product with decreased bacterial viability relative to an untreated crop plant or plant food product, the treated crop plant or plant food product comprising at least a 1-log reduction in bacterial viability relative to the untreated crop plant or plant food product.

18. (canceled)

19. The treated crop plant or plant food product of claim 17, wherein the treated crop plant or plant food product comprises at least a 3-log reduction in bacterial viability.

20. (canceled)

21. (canceled)

22. The treated crop plant or plant food product of claim 17, wherein the treated crop plant or plant food product has decreased bacterial viability of at least one of E. coli and S. aureus.

23. (canceled)

24. The treated crop plant or plant food product of claim 17, wherein the treated crop plant or plant food product has an electrolyte conductivity of less than about 100 microSiemens/10 g of treated crop plant or plant food product.

25. (canceled)

26. A method of decreasing the viability of bacteria on a crop plant or plant food product, the method comprising:
exposing a crop plant or plant food product to a plasma activated medium, thereby reducing the viability of bacteria present on the crop plant or plant food product prior to the exposure.

27. The method of claim 26, wherein the medium is selected from a gas and/or a fluid.

28. (canceled)

29. The method of claim 28, wherein the viability of the bacteria is reduced by at least 3-log following the exposure.

30. (canceled)

31. (canceled)

32. (canceled)

33. (canceled)

34. (canceled)

35. (canceled)

36. (canceled)

37. The method of claim 36, further comprising a biological additive is selected from the group consisting of lauric acid, cinnamaldehyde, and carvacrol.

38. (canceled)

39. (canceled)

40. (canceled)

41. The method of claim 26, wherein the crop plant or plant food product exposed to the plasma activated medium has an electrolyte conductivity of less than about 100 microSiemens/10 g of exposed crop plant or plant food product.

42. (canceled)

43. (canceled)

44. A fluid for treating a crop plant or food product comprising:
water and a biological additive, wherein at least one of the water and biological additive are activated with plasma.

45. (canceled)

46. The fluid of claim 44, wherein the biological additive is one of lauric acid, cinnamaldehyde, and carvacrol.

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)
